(19) United States
(12) Patent Application Publication
(10) Pub. No.: US 2012/0311914 A1
(43) Pub. Date: Dec. 13, 2012

(54) ROD AND REEL LEASH SYSTEM

(75) Inventors: Michael W. Appel, Durham, NC (US); Michael W. Biggs, Raleigh, NC (US); Michael W. Pruitt, Raleigh, NC (US)

(73) Assignee: Tri-Mik Products, Inc.

(21) Appl. No.: 13/156,480

(22) Filed: Jun. 9, 2011

(51) Int. Cl. A01K 97/10; A01K 99/00

(52) U.S. Cl. 43/4.5; 43/25

(57) ABSTRACT

The present invention relates to a rod and reel leash system wherein a restraint line is attached to the rod and reel that comprises a variable drag which increases as the restraint line is taken from the spool so that the chance of a sudden stop at the end of the line is reduced along with a reduction in the chance of, breaking the fishing line or damaging the rod and reel.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to fishing and fishing rods. In particular, it relates to a rod and reel leash.

2. Description of Related Art

Fishing rods and reels are extremely expensive equipment. The equipment can cost hundreds and even thousands of dollars, and as such is an investment that needs to be protected. In addition, they require maintenance to keep in working order. When using the equipment on a boat, there is always the possibility that the equipment could accidently fall overboard and be lost. While fishing, it is also possible that a fish hitting the bait on the rod and reel line could pull the rod and reel overboard while the rod and reel are unattended or not being grasped firmly enough.

For many years the most popular way to prevent loss of the rod and reel is to make sure the reel is firmly attached to the rod and to use a leash to connect to the reel at one end to some fixed object anchor point, like the cleat of a boat or other fixed object within the boat at the other end. The leash comprises a high strength line (such as polymeric or metal line or strap of heavy gauge that is much thicker in diameter than fishing line) that is then clipped, strapped, or wrapped to the reel, or in some cases the rod. If the rod and reel goes overboard, it then becomes a simple matter to grab the high strength restraint line and pull the rod and reel back onboard.

However, while these devices mostly have their uses, in the occasion where a fish takes the bait and pulls the rod and reel overboard, a secondary problem occurs. If the fish has taken the bait and runs and has pulled the rod and reel overboard, when the leash reaches its full length, there is a sudden stop of the unwinding of the line, which often results in the breakage of the fishing line and the loss of a prize winning tournament fish as well as the rod and reel. Some attempts to alleviate the problem have included utilizing elastic for the strap but at some point the line will still reach an end point.

### BRIEF SUMMARY OF THE INVENTION

The problems that have existed for many years can be dealt with utilizing the present method and device. In particular, by utilizing a restraint line on a take up spool that comprises a variable drag which increases as the restraint line is taken from the spool, the chance of a sudden stop at the end of the line is reduced along with a reduction in the chance of breaking the fishing line or damaging the rod and reel. This is especially useful when a fish hits an unattended rod and reel assembly and pulls the assembly into a body of water where it would be otherwise lost in such body of water.

Accordingly, in one embodiment there is a system for preventing the loss of a fishing rod and reel assembly comprising:
a) a fishing rod and reel assembly;
b) an anchor point; and
c) a take up spool having a restraint line of a selected length having a first end and a second end, the restraint line wound on the take up spool, the first end attached to the take up spool and wherein the take up spool has a release brake which increases the resistance to remove line from the spool as the line is unwound from the spool, the second end of the line is attached to the rod and reel assembly and wherein the take up spool is attached to the anchor point.

In yet another embodiment there is a method for preventing the loss of a rod and reel assembly that is dropped or lost in a body of water comprising:
a) selecting a take up spool having a restraint line of a selected length having a first end and a second end, the restraint line wound on the take up spool, the first end attached to the take up spool and wherein the take up spool has a release brake which increases the resistance to remove restraint line from the spool as the restraint line is unwound from the spool;
b) attaching the spool to an anchor point; and
c) attaching the second end to the rod and reel assembly.

### BRIEF DESCRIPTION OF THE DRAWINGS

FIG. 1 is a perspective view of the spool of the present invention.

FIG. 2 is a perspective view of the system of the present invention mounted on and in a boat gunwale.

FIG. 3 is a perspective view of a rod and reel in a body of water being prevented from loss with the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” if used, preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “a fishing rod and reel assembly” can refer to any fishing rod and reel combination wherein the reel is attached to the rod for fishing. That assembly includes such assembly for deep sea fishing, lake, river, or other fishing where a fishing reel is attached to a fishing rod by the means normally used in the art for such attachment. As used herein a “body of water” refers to a body of water that is being used for fishing with the rod and reel assembly such as oceans, seas, rivers, lakes, and the like. In general, the body of water will be deep enough or long enough that if the rod and reel assembly is in the water, such as by dropping it in or a fish pulling it into the water, the rod and reel would be lost without some form of restraint device.

As used herein an “anchor point” refers to a place where the spool of the present invention can be attached during use. Therefore, it is a fixed place right where the fisherman is utilizing the rod and reel assembly during the fishing process. For example, the anchor point could be a cleat on the boat, T-Top assembly of the boat, radar arch on the boat, step of the boat, gunwales of the boat, a rod holder or any fixed point on a boat, or the like. In general, it needs to be a point that can hold the spool against the pull of the restraint line that is attached to the rod and reel assembly.

As used herein “line” or “restraint line” refers to a selected length of a tether that can be wound onto a spool. It needs to be stronger (i.e. greater breaking resistance or tensile strength) than the fishing line used on the rod and reel assembly it is being used with for fishing purposes. For example, a metal line such as stainless steel (coated or uncoated) or heavy gage plastic line. The “selected length” would be of a desired length to allow the line to play out without sudden stoppage. In one embodiment the length of the line is at least 12 feet and in another embodiment it is at least 6 feet. Length will vary based on the size of the boat whereas a longer restraint line would be needed for a larger boat and a shorter restraint line would be needed for a smaller boat. The line will have a first end for attaching to the rod and reel assembly and a second end for attaching to the take-up spool. The line can be attached to the spool by any method used to attach a line to a spool such as crimp, hook, or knot. The line can be attached to the rod and reel assembly by attaching a clip, hook and loop fastener, strap or other attachment means suitable for attaching a line to a rod and reel assembly.

As used herein a “take-up spool” refers to a winder consisting of a revolving wheel that the restraint line can wind around. It must also include some device or means for attaching the spool firmly to the anchor point. Examples include screw eyeholes, u-bolt and machined mounting bracket (which can be used to tie the spool to a rod holder or the like), permanent attachments (welding, fastening or the like which once attached are not intended to be removed). Further there is a “release brake” device or means for placing drag on the restraint line as it is withdrawn. In an embodiment the drag is such that the resistance increases as the restraint line is withdrawn from the spool. By providing resistance, the restraint line won't suddenly end which can end up breaking the rod and reel fishing line or damaging the rod and reel assembly. Further, once the resistance is almost at the point where it is impossible to withdraw more line (before one runs out of the restraint line), the spool would lock the removal of an additional restraint line but the locking would have been so gentle that the fishing line would be unlikely to break or cause damage to the rod and reel assembly. The resistance might be directly related to the selected length of the restraint line such that a long restraint line would have a more gradual resistance than a shorter restraint line. In one embodiment, the spool has an adjustable resistance such that the starting resistance could be set, how much restraint line comes out before the restraint line locks, the resistance starts at a desired resistance, or the like. In another embodiment the brake can lock the restraint line from unwinding by selection of the lock function.

The spool could also comprise a housing to protect the restraint line, winder, and other mechanism from damage. Another embodiment would include a retraction system so that, for example, a tightened winder spring is utilized to recoil the restraint line back onto the spool either to bring the spool back to a desired static position or to retrieve the rod and reel that has been dropped overboard. Absent an automatic retraction system a manual system, such as a winding handle, could be utilized. Retraction systems for spools are well known and within the skill of the art to adapt to use with this system. The winding system and remaining parts need to be constructed strong enough to withstand the pressure of the assembly being overboard. In one embodiment, the devices are manufactured of metals such as stainless steel, aluminum and polymeric, or the like though brake parts could be made of other materials useful for braking or braking circuitry applied to servo motor. One skilled in the art would be able to construct the device especially in view of the examples in the figures and the description herein.

In the practice of the present invention's method, the fisherman selects the rod and reel assembly. The take-up spool as described about is attached to the desired anchor point. The first end of the restraint line is then attached to the rod and reel assembly, for example, by clipping the restraint line to the rod and reel crossbar or restraint attachment eyelet where provided. The fisherman then adjusts the resistance, turns it on, if on/off is provided, and is ready to fish and can set the assembly down, in the rod holder or loosely hold it without fear of losing the rod. If the rod and reel assembly is pulled or dropped into the water, e.g. a fish hits the fishing line and pulls the rod and reel into the body of water, the user can wait until the resistance has slowed the taking of the rod and reel assembly or has taken it to a stop. The fisherman can then cause the restraint line to retract onto the spool or manually pull the restraint line and retrieve the rod and reel.

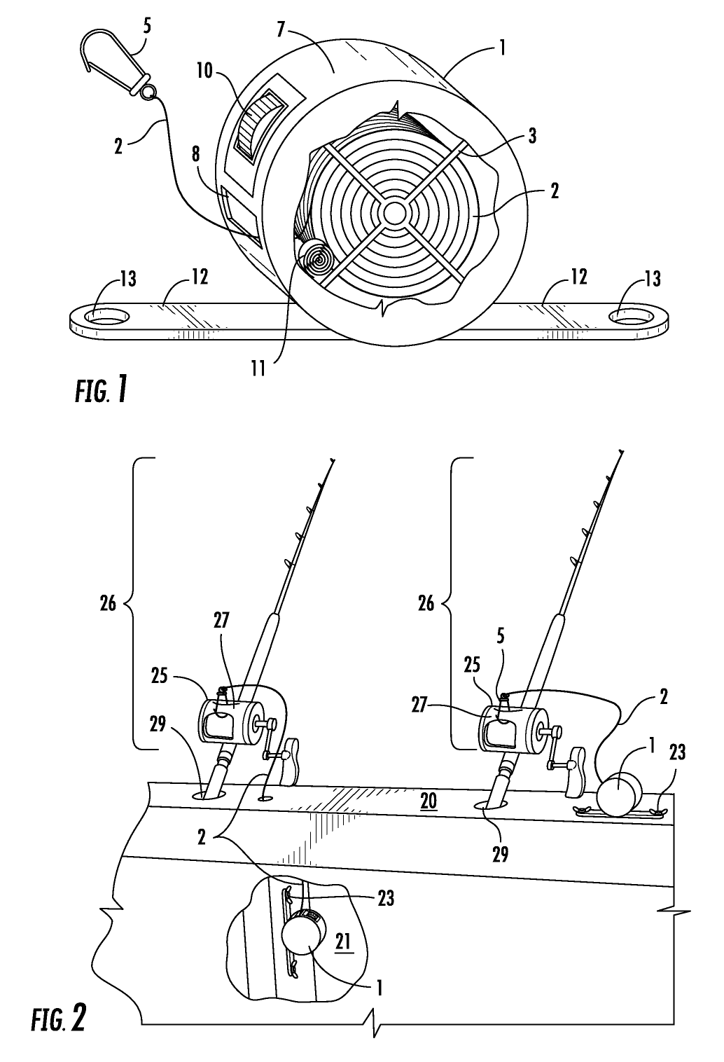

Now referring to the figures, FIG. 1 is a perspective view of an embodiment of the spool of the present invention. Spool 1 consists of restraint line 2 which is shown on wheel 3 via the see through area exposing the inside of the spool for figure purposes. Restraint line 2 has clip 5 which can be utilized to attach to a rod and reel assembly. The spool 1 has a protective housing 7 which protects the inside of spool 1 from the elements. Housing 7 has opening 8 where restraint line 2 exits the housing 7. Switch 10 is the adjustable switch for adjusting the brake system of the wheel. One skilled in the art could utilize a spring system, a brake pad, a servo motor and the like for providing resistance and providing increasing resistance of the restraint line 2 to its removal from housing 7. Tensioned spring 11 is utilized as the retraction system for retracting the restraint line 2 onto the wheel 3.

The spool 1 is mounted to a desired anchor point by means of mounting wings 12. Each mounting wing 12 has screw/bolt holes 13 for screwing or bolting the device into the anchor point where the anchor point is something like a rod holder, rail, or boat surface. The wings 12 could be utilized in a manner where a u-bolt, machined strap, or the like is used to tie the wings to the anchor point.

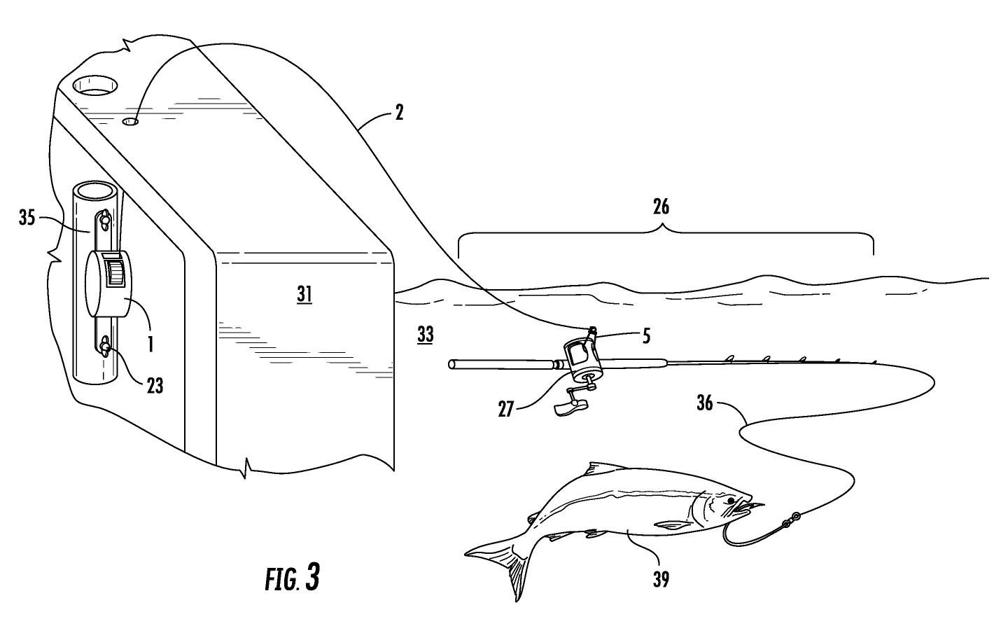

FIG. 2 is a perspective view of the system of the present invention. Spool 1 is mounted to an anchor point, in one instance on rod holder mounted within a gunwale 20 and in another embodiment it is mounted to a rod holder that is mounted outside of the gunwale and elsewhere on the boat. The mounting is by u-bolt, machined strap, or the like screws 23 in wings 12. Clip 5 is attached to reel 25 of rod and reel assembly 26. In this embodiment the clip is on a crossbar 27 of reel 25. In this embodiment rod and reel assembly 26 is shown standing in holder 29 built into the gunwale 27 though the assembly 26 could be easily laid down on the bottom of the boat.

FIG. 3 is a perspective of a rod and reel assembly pulled into the water by a fish hitting the rod and reel line. In this view spool 1 is mounted onto the rod holder 35 outside of the gunwales of a boat and on the T-top rails 31 of the boat in the bay water 33. Rod and reel assembly 26 originally seats in rod holder 35 which is bolted to T-top rails 31 of the boat. Fisherman is not shown in boat 30 on the bay or is not otherwise attentive to the assembly 26. If the fishing line of the assembly 26 is baited and in water 33, a fish can always hit on the bait. If the assembly 26 is unattended, it is pulled into the water when fish 39 has grabbed the bait. In this view the resistance button 10 is adjusted to allow the fish 39 to run with fishing line 36 and the rod and reel assembly 26. The adjustable resistance keeps fish 39 from breaking either restraint line 2 or fishing line 36 which would result in loss of rod and reel assembly 26. The restraint line 2 can be rewound on to spool 1, thus retrieving the rod and reel assembly 26.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for preventing the loss of a fishing rod and reel assembly comprising:
a) a fishing rod and reel assembly;
b) an anchor point; and
c) a take up spool having a restraint line of a selected length having a first end and a second end, the restraint line wound on the take up spool, the first end attached to the take up spool and wherein the take up spool has a release brake which increases the resistance to remove line from the spool as the line is unwound from the spool, the second end of the line is attached to the rod and reel assembly. and wherein the take up spool is attached to the anchor point.

2. The system according to claim 1 wherein the take up spool has a spring-tensioned winding device for retracting the restraint line onto the spool.

3. The system according to claim 1 wherein the anchor point is selected from the group comprising, a T-Top assembly of the boat, radar arch on the boat, gunwales of the boat and a rod holder,

4. The system according to claim 1 wherein the second end comprises a device for attaching to the rod and reel assembly selected from the group comprising a clip, a hook and loop fastener and a strap.

5. The system according to claim 1 wherein the take up spool is housed in a metal or polymeric housing.

6. The system according to claim 1 wherein the restrain line length is variable based on size of boat.

7. The system according to claim 1 wherein the brake increases the resistance until the line locks.

8. The system according to claim 1 wherein the brake resistance is adjustable.

9. A method for preventing the loss of a rod and reel assembly that is dropped or lost in a body of water comprising:
a) selecting a take up spool having a restraint line having a first end and a second end, the restraint line wound on the take up spool, the first end attached to the take up spool and wherein the take up spool has a release brake which increases the resistance to remove restraint line from the spool as the restraint line is unwound from the spool;
b) attaching the spool to an anchor point; and
c) attaching the second end to the rod and reel assembly.

10. The method according to claim 9 wherein the take up reel has a spring-tensioned winding device for retracting the restraint line onto the spool.

11. The method according to claim 9 wherein the anchor point is selected from the group comprising a T-Top assembly of a boat, radar arch on a boat, gunwales of a boat, and a rod holder.

12. The method according to claim 9 wherein the second end comprises a device for attaching to the assembly selected from the group comprising a clip, a hook and loop fastener and a strap.

13. The method according to claim 9 wherein the brake increases the resistance to remove the restraint line until the line locks in place.

14. The method according to claim 9 wherein the brake resistance is adjustable and is adjusted by a user of the spool.

15. The method according to claim 9 wherein the restraint line is manually retracted when the rod and reel assembly is in the body of water.
